(19) United States
(12) Patent Application Publication
(10) Pub. No.: US 2025/0058492 A1
(43) Pub. Date: Feb. 20, 2025

(54) ENGINEERED WOOD ADHESIVES INCLUDING ENHANCED PROTEIN PEA FLOUR AND ENGINEERED WOOD THEREFROM

(71) Applicant: CARGILL, INCORPORATED, Wayzata, MN (US)

(72) Inventors: David Edward GARLIE, Eau Claire, WI (US); Flave Eugene MARKLAND, JR., Atkins, IA (US); Shuang ZHOU, Marion, IA (US)

(73) Assignee: CARGILL, INCORPORATED, Wayzata, MN (US)

(21) Appl. No.: 18/721,352

(22) PCT Filed: Dec. 16, 2022
(86) PCT No.: PCT/US2022/081889

§ 371 Date: Jun. 18, 2024

Related U.S. Application Data
(60) Provisional application No. 63/265,963, filed on Dec. 23, 2021.

(51) Int. Cl. B27N 1/02; B27N 1/00; B27N 3/00; B27N 3/04

(52) U.S. Cl. CPC B27N 1/0209; B27N 1/006; B27N 3/002; B27N 3/04

(57) ABSTRACT

The instant disclosure relates to an engineered wood precursor mixture. The engineered wood precursor mixture includes wood components and a binder reaction mixture. The binder reaction mixture is present in a range of from 3 parts to 25 parts per 100 parts of the dry weight of the plurality of wood components. The binder reaction mixture includes an aqueous portion including a glycerol component. The glycerol component includes glycerol or an oligomer of glycerol in a range of from 5 wt % to 65 wt % or 5 wt % to 50 60 wt %, based on the dry weight of the binder reaction mixture. The binder reaction mixture further includes an at least partially non-dissolved polypeptide-containing component comprising an enhanced protein pea flour. The enhanced protein pea flour comprises 40 wt % to 85 wt % protein.

### CROSS-REFERENCE TO RELATED APPLICATIONS

This application claims the benefit of U.S. Provisional Application No. 63/265,963, filed Dec. 23, 2021, which is incorporated by reference herein in its entirety.

### BACKGROUND

The most commonly used wood adhesives are phenol-formaldehyde resins (PF) and urea-formaldehyde resins (UF). There are at least two concerns with PF and UF resins. First, volatile organic compounds (VOC) are generated during the manufacture and use of lignocellulosic-based composites. An increasing concern about the effect of emissive VOC, especially formaldehyde, on human health has prompted a need for more environmentally acceptable adhesives. Second, PF and UF resins are made from petrochemical products (e.g., petroleum-derived products or natural gas derived products). The reserves of petroleum are naturally limited. The wood composite industry would greatly benefit from the development of formaldehyde-free adhesives made from renewable natural resources.

### SUMMARY OF THE INVENTION

Various aspects of the instant disclosure relate to an engineered wood precursor mixture. The engineered wood precursor mixture includes a plurality of wood components and a binder reaction mixture present in a range of from 3 parts to 25 parts per 100 parts of the dry weight of the plurality of wood components. The binder reaction mixture includes an aqueous portion including a glycerol component comprising glycerol or an oligomer of glycerol. The glycerol component is present in a range of from 10 wt % to 65 wt % or 10 wt % to 50 wt %, based on the dry weight of the binder reaction mixture. The binder reaction mixture further includes an at least partially non-dissolved polypeptide-containing component in a range of from 20 wt % to 85 wt % (preferably from 30 wt % to 70 wt % and more preferably from 40 wt % to 60 wt %), based on the dry weight of the binder reaction mixture, the polypeptide-containing component comprising an enhanced protein pea flour. The enhanced protein pea flour includes from 40 wt % to 85 wt % protein or from 40 wt % to 60 wt % protein (for example, from 45 wt % to 60 wt % protein or from 50 wt % to 57 wt %).

A method of making an engineered wood includes combining a solid polypeptide-containing component comprising an enhanced protein pea flour, wherein the enhanced protein pea flour comprises 40 wt % to 60 wt % protein (preferably 45 wt % to 60 wt % protein and more preferably 45 wt % to 55 wt % protein) with a plurality of wood components to produce a solution comprising the polypeptide-containing component and the wood components. The method further includes combining a solution comprising the polypeptide-containing component and the wood components with an aqueous mixture. The aqueous mixture comprising a glycerol component, water, a base, optionally a sodium sulfite, a carbohydrate-containing component, a borax, or a mixture thereof, to produce a binder reaction mixture. The method further includes curing the binder reaction mixture to form the engineered wood.

According to further aspects, a method of making an engineered wood includes combining a glycerol component comprising glycerol or an oligomer of glycerol, water, a base, optionally a carbohydrate-containing component, sodium sulfite, borax, or a mixture thereof, to produce an aqueous mixture. The method further includes combining the aqueous mixture with a plurality of wood components and further with a solid polypeptide-containing component to form a polypeptide-containing component comprising an enhanced protein pea flour. The enhanced protein pea flour comprises 40 wt % to 60 wt % protein (preferably 45 wt % to 60 wt % protein and more preferably 45 wt % to 55 wt % protein). The method further includes curing the third mixture to form the engineered wood.

Typically, during curing, a platen is heated to a temperature of at least 204° C., at least 246° C. in a range of from 204° C. to 315° C., 204° C. to 260° C., 204° C. to 232° C., 204° C. to 226° C., 210° C. to 221° C., less than 315° C., or preferably less than 230° C.

As used herein “mixture” means a portion of matter including two or more chemical substances.

### BRIEF DESCRIPTION OF THE FIGURES

The drawings illustrate generally, by way of example, but not by way of limitation, various embodiments of the present invention.

FIG. 1 is sectional view of an engineered wood product, in accordance with various embodiments.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “substantially” as used herein refers to a majority of, or mostly, as in at least about 90%, 95%, 99.5%, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or about 0 wt %.

In the methods described and claimed herein, labels for individual steps do not imply a specific order unless stated to the contrary.

According to various aspects of the instant disclosure, an engineered wood product is described. The engineered wood product can typically take the form of a particle board, medium density fiber board, high density fiberboard, oriented strand board, engineered wood flooring, and combinations thereof. In preferred aspects, the engineered wood product takes the form of a particle board. The engineered wood product can be sized to have any suitable dimensions. For example, the engineered wood product can be sized to be 1.2 meters wide and 2.6 meters long, or 1.3 meters wide and 2.1 meters long. These dimensions are merely meant to be examples and do not limit the sizes of engineered wood products that can be produced.

The engineered wood product can typically include a variety of constituents. For example, the engineered wood product can typically include a plurality of wood components bound together by a binder that is a reaction product of a binder reaction mixture including an at least partially non-dissolved polypeptide component distributed about the binder reaction mixture as well as an aqueous portion including a glycerol component including a glycerol or an oligomer of glycerol. As understood an oligomer of glycerol can include 2 to 8 glycerol repeating units, 3 to 7 glycerol repeating units, or 3 to 5 glycerol repeating units. The aqueous portion can further include a carbohydrate-containing component, sodium sulfite, sodium bisulfite, sodium metabisulfite, sodium trimetaphosphate, a borax, calcium carbonate, a base, or a mixture thereof. In the engineered wood product, the binder that is the reaction product of the binder reaction mixture, can typically be present in a range of from 3 parts to 25 parts binder per 100 parts of the dry weight of the wood components, for example from 4.5 parts to 23.5 parts, 3parts to 20 parts, or 6 parts to 17 parts or 6 parts to 10 parts, 8 parts to 17 parts 100 parts of dry weight of the wood components. Having levels of binder in these ranges can contribute to the engineered wood product having favorable or desirable physical properties, while effectively minimizing the amount of binder that is needed to bind the plurality of wood components. The binder can be characterized as a biopolymer.

The internal bond strength is a quantity that measures a material's ability to resist rupturing in the direction perpendicular to the plane of the material's surface. The internal bond strength can be measured by ASTM D 1037-06a. The engineered wood shows internal bond strength values of at least 40 psi, in a range of 40 psi to 120 psi or 60 psi to 95 psi.

A benefit, of using the engineered wood products formed using the materials and methods described herein, is that the properties of the engineered wood products, typically are generally comparable to those of a corresponding engineered wood product differing in that it uses a urea-formaldehyde (UF) binder or a methylene diphenyl diisocyanate (e.g., a pre-polymerized methylene diphenyl diisocyanate) binder. Urea-formaldehyde resin is a synthetic resin produced by the chemical combination of formaldehyde (a gas produced from methane) and urea (a solid crystal produced from ammonia). Urea-formaldehyde resins are used mostly for gluing plywood, particleboard, and other wood products. Urea-formaldehyde resins polymerize into permanently interlinked networks which are influential in the strength of the cured adhesive. After setting and hardening, urea-formaldehyde resins form an insoluble, three-dimensional network and cannot be melted or thermo-formed.

However, there are a number of disadvantages associated with using urea-formaldehyde or methylene diphenyl diisocyanate. For example, addition of water, in high temperature, cured urea-formaldehyde can hydrolyze and release formaldehyde, this weakens the glue bond and can be toxic. Moreover, urea-formaldehyde must be used in a well ventilated area because uncured resin is irritating and can be toxic. Additionally, urea-formaldehyde adhesives generally have a limited shelf life.

The materials described herein can address at least some of these drawbacks and, in particular, prevent the outgassing of substantially any formaldehyde or methylene diphenyl diisocyanate. Moreover, according to various aspects, the internal bond strength of the engineered wood can be substantially similar to the internal bond strength of a corresponding engineered wood differing in that the reaction product comprises urea-formaldehyde, methylene diphenyl diisocyanate binder, or a mixture thereof. More specifically, the internal bond strength, of the engineered wood can be within 1% to 10%, 1% to 5%, or is substantially identical to the internal bond strength of the corresponding engineered wood differing in that the reaction product comprises urea-formaldehyde, methylene diphenyl diisocyanate binder, or a mixture thereof. However, in a further aspect, the internal bond strength can be within 50% to 150% of the corresponding engineered wood differing in that the reaction product comprises urea-formaldehyde, methylene diphenyl diisocyanate binder, or a mixture thereof.

The properties of the engineered wood products described herein can be further achieved or enhanced for example by distributing the binder such that it is substantially homogenously distributed about the plurality of wood components. Other properties such as a thickness swell % can typically be achieved or enhanced by adding a swell-retardant agent such that it is distributed about the engineered wood. The swell-retardant agent can include a wax emulsion that can sustain (e.g., remain stable) a high pH environment that is greater than 10. Where present, the swell-retardant can be from 0.1 wt % to 1 wt % or from 0.5 wt % to 0.7 wt % of the engineered wood product.

Although the engineered wood product has been described as a singular object, it is within the scope of this disclosure for the engineered wood product to be a component of a larger structure. For example, the engineered wood product can be part of a laminate structure where the engineered wood product constitutes an inner or outer layer of the laminate structure. The engineered wood product can be in contact with a core structure (e.g., a wood, plastic, or metal core) or another engineered wood product that has a substantially identical construction or a different construction.

The engineered wood product can be a multi-layer wood product. For example, the engineered wood product can include a first face layer, a second face layer, and a core layer disposed between the first face layer and the second face layer. The chemical composition of the first face layer, second face layer, and core layer can be the same. However, the average particle size of the first face layer and the second face layer can be smaller than the average particle size of the core layer. Smaller wood particles in the face layers result in the face layers having a higher density than the core layer. Without intending to be bound to any theory, it is thought that the higher density in the face layers, relative to the core layers, may lead to improvement in the overall balance of the physical properties of the engineered wood product.

A density of the engineered wood is from 0.2 g/cm³ to 0.8 g/cm³, 0.60 g/cm³ to 0.75 g/cm³, 0.65 g/cm³ to 0.75 g/cm³, or from 0.65 g/cm³ to 0.70 g/cm³.

The engineered wood described herein is formed from an engineered wood precursor mixture. The engineered wood precursor mixture includes at least a plurality of wood components, an aqueous portion of a binder reaction mixture and a polypeptide-containing component distributed about the binder reaction mixture. The plurality of wood components can include one or more wood particles, one or more wood components, one or more wood chips, or one or more wood strands. The wood components can include a wood material such as pine, hemlock, spruce, aspen, birch, maple, or mixtures thereof.

The glycerol component, including glycerol or an oligomer of glycerol, can be present in the aqueous portion of the binder reaction mixture. The glycerol component can be present in a range of from 10 wt % to 65 wt % or 10 wt % to 50 wt %, (e.g., from 10 wt % to 65 wt %, from 10 wt % to 30 wt %, from 20 wt % to 30 wt %, at least 10 wt %, at least 20 wt %, or at least 30 wt %) based on a dry weight of the binder reaction mixture. The glycerol component typically comprises at least 80 wt % glycerol on a dry weight basis (for example, at least 85 wt %, at least 90 wt %, or at least 95 wt % on a dry weight basis). The glycerol or oligomer of glycerol can include pure glycerol or an oligomer of glycerol. For example, the glycerol or oligomer of glycerol can be diluted. For example, the glycerol component can include a crude glycerol. A crude glycerol can include 30 wt % to 95 wt % glycerol or 55 wt % to 95 wt % glycerol. An exemplary example of a crude glycerol is a mixture including 10 to 20 wt % water (for example 15 wt %), 3 wt % to 7 wt % NaCl (for example 4 wt % to 5 wt %) and 80 wt % to 92 wt % glycerol (for example 87.5 wt %). A crude glycerol may include additional materials known to one of skill in the art. For example, the crude glycerol can include less than 3 wt %, less than 2 wt %, or less than 1 wt % NaCl, this can be beneficial if the wood product used is a recycled wood particle. For example, the glycerol can be a technical glycerol that includes a high concentration of glycerol and less than 1 wt % methanol, less than 0.5 wt % methanol, or less than 0.1 wt % methanol and less than 1 wt % NaCl, less than 0.5 wt % NaCl, or less than 0.1 wt % NaCl. For example, the technical glycerol includes at least 98 wt % glycerol. Advantageously, it is found that binders including crude glycerol can provide an engineered wood product having suitable performance.

The carbohydrate-containing component can be in an aqueous form in a range of from 2 wt % to 40 wt % or 5 wt % to 15 wt % based on a dry weight of the binder reaction mixture. The carbohydrate-containing component includes fructose, glucose, sucrose, or a mixture thereof. Preferably, the carbohydrate-containing component includes fructose, glucose, or a mixture thereof. The carbohydrate-containing component does not include glycerol or an oligomer of glycerol. For example, the carbohydrate-containing component includes a high fructose corn syrup. Fructose, glucose, sucrose or a mixture thereof can constitute at least 80 wt % (e.g., at least 85 wt %, at least 90 wt %, and in some instances at least 94 wt %) of the carbohydrate-containing component.

Typically, the carbohydrate(s) of the carbohydrate-containing component will be a carbohydrate that has at least one reducing group (the reducing group can be a reducing end group). It is possible for the carbohydrate-containing component to have a mixture of carbohydrates with a reducing group and carbohydrates without a reducing group too, but in these cases there are likely to be at least some carbohydrates with a reducing group. The reducing group(s) (e.g., aldehyde group(s), ketone group(s), or a mixture thereof) available on the carbohydrates allows for a bond to formed between it and an amine group of the polypeptide component during curing to form a biopolymer or network thereof.

The aqueous portion can further include a base. The base can typically be present in the binder reaction mixture in a range of from 1 wt % to 33 wt % or 3 wt % to 10 wt % or 4 wt % to 8 wt %, based on a dry weight of the binder reaction mixture. The base can typically be added to such a degree that a pH of the aqueous portion of the binder reaction mixture is greater than 10, for example greater than 10.5, greater than 11, greater than 11.5, greater than 12.0. The pH, therefore, is typically in a range of from 10 to 14 or 10 to 13.5 or 11 to 14. Typically, the base includes NaOH, magnesium oxide, KOH or mixtures thereof. For example, the base can include another strong base (for example, Ca(OH)₂ or another base that completely dissociates in solution) or sodium carbonate. For example, ammonium or ammonia hydroxide can be used as the base, but these are not preferred because of their propensity to generate gaseous ammonia. For example, the base includes solely NaOH.

While not intending to be limited to any theory, it is believed that the base, at the disclosed concentration results in the high pH environment enhances the reaction between the carbohydrate-containing component (where present), polypeptide-containing component, and wood component to form a biopolymer network enveloping the wood component. For example, it is believed that the base can help to dissolve at least a portion of individual wood components. This, in turn, allows the binder precursor solution to penetrate at least partially into the interior of the individual wood component. Therefore, when the binder precursor is subjected to curing a greater degree of interlocking between the binder and the individual wood components can be achieved. While not intending to be bound to any theory, it is believed that this in conjunction with the hydrogen bonds formed between the glycerol or oligomer of glycerol with the polypeptide-containing component, potentially the wood component and where present the carbohydrate-containing component can help to improve the physical properties of the engineered wood. The relatively high pH values described herein, are not described in U.S. Pat. No. 8,501,838.

In certain aspects, the engineered wood precursor mixture can include sodium sulfite, sodium bisulfite, sodium metabisulfite or a mixture thereof. Where present, the sodium sulfite, sodium bisulfite, or a mixture thereof is in a range of from 0.5 wt % to 10 wt %, from 1 wt % to 5 wt %, or from 1.5 wt % to 5 wt %, based on the dry weight of the binder reaction mixture. Including sodium sulfite, sodium bisulfite, or a mixture thereof can help to increase the strength of the resulting engineered wood product. For example, they can help to increase the internal bond strength of the engineered wood, relative to a corresponding engineered wood that is free of sodium sulfite, sodium bisulfite, sodium metabisulfite, or a mixture thereof. However, in certain aspects, including sodium sulfite, sodium bisulfite, sodium metabisulfite or a mixture thereof such that the amount of polypeptide-containing component in the aqueous portion needs to be reduced, the strength of the engineered wood can be decreased.

According to various aspects, the aqueous portion can further include a borax. The term borax is often used for a number of closely related minerals or chemical compounds that differ in their crystal water content. Examples of suitable borax compounds include sodium tetraborate decahydrate (or sodium tetraborate octahydrate), sodium tetraborate pentahydrate, anhydrous sodium tetraborate, and mixtures thereof. Where present the borax can be in a range of from 1 wt % to 15 wt % based on the dry weight of the binder reaction mixture or 3 wt % to 6 wt % or 4.5 wt % to 5.5 wt %.

The aqueous portion can further include calcium carbonate. Where present, calcium carbonate can be in a range of from 1 wt % to 15 wt %, based on the dry weight of the binder reaction mixture or 3 wt % to 8 wt %.

The binder reaction mixture further includes an at least partially non-dissolved polypeptide-containing component distributed about the wood component, glycerol or oligomer of glycerol, and where present, the carbohydrate-containing component. The concentration of polypeptide-containing component is measured based on the dry weight of the binder reaction mixture. The concentration of the polypeptide-containing component can typically be in a range of from 20 wt % to 85 wt %, 30 wt % to 70 wt %, or 40 wt % to 60 wt %.

The polypeptide-containing component includes an enhanced protein pea flour. The enhanced protein pea flour includes from 40 wt % to 85 wt % protein or from 40 wt % to 60 wt % protein (for example, from 45 wt % to 60 wt % protein or from 50 wt % to 57 wt %). The enhanced protein pea flour can be produced by dry milling a pea flour and classifying the milled pea flour to increase the protein content.

The polypeptide-containing component can take the form of a solid (e.g., a powder) or can be in the form of a slurry or suspension (e.g., contains both solid and liquid phases).

As described previously, the binder is substantially free of a urea-formaldehyde. Therefore, the precursors described herein are also free of a urea-formaldehyde. For example, the mixture can typically include less than 5 wt % of urea-formaldehyde or be substantially free of urea-formaldehyde.

The moisture content of the mixture of the binder reaction mixture and the plurality of wood components can be carefully controlled. For example, the moisture content of the binder reaction mixture and the plurality of wood components, together, is typically in a range of from 7% to 25%, 9 to 15%, or 10% to 13%. The moisture content can affect the ability to disperse the components of the mixture about the wood components and the reactivity of the substrates. When the engineered wood includes multiple layers (e.g., a first face layer 102, second face layer 104, and a core layer 106), the moisture content of the different layers can be substantially the same or different.

The moisture content can be tuned, for example by increasing or decreasing the moisture content in the binder. For example, if the moisture content in the wood is low, the moisture content in the binder can be increased to bring the total moisture content of the mixture of the binder and plurality of wood components to a desired level. For example, moisture can be added to the binder by spraying water to the binder distributed on the wood components. However, in certain aspects, water can simply be added to the glycerol or oligomer of glycerol, and where present, the carbohydrate-containing component before it is applied to the wood component. This can give better distribution of the moisture across the mixture of binder and wood components. As used herein a moisture content means the total moisture content (by weight percent) of the mixture of the wood components and binder reaction mixture. This is referred to in the Examples here in as “W_{T}”. Alternatively, the moisture content of the mixture of the wood components and binder reaction mixture is referred to as a “mat moisture”. As a further alternative, the total moisture content of the wood components and the binder reaction mixture is referred to as the “moisture content of the binder reaction mixture that is applied to the plurality of wood components.”

The engineered wood described herein can be made or manufactured according to many suitable methods. As an example, a method can include (a) combining the glycerol component including glycerol or an oligomer of glycerol, water, and the base to produce. For example, additional components such as sodium sulfite, any carbohydrate-containing component described herein, any borax described herein, or a mixture thereof can be combined to produce the first mixture.

After the components are sufficiently mixed, the method can further include (b) combining the mixture produced at (a) with the plurality of wood components. To help to achieve a uniform blend, combining at (b) is typically performed by spraying the mixture produced at (a) to the plurality of wood components. The spraying can typically occur for a time in a range of from 1 minute to 60 minutes or 1 minute to 10 minutes. As used herein “mixing” means that the components are combined or added to each other to effect combination. As used herein “combining” can, for example, include spraying at least one component to another component or mixing components. In some examples “mixing” can include stirring a plurality of the components.

The glycerol or oligomer of glycerol can be in a range of from 10 wt % to 65 wt % or 10 wt % to 50 wt % or 15 wt % to 40 wt %, or 20 wt % to 40 wt %, based on the dry weight of polypeptide-containing component, base, and glycerol or the oligomer of glycerol component and, where present, sodium sulfite, a carbohydrate-containing component, borax, or a mixture thereof. Where present, the carbohydrate-containing component in a range of from 2 wt % to 40 wt % or 5 wt % to 20 wt %, based on the dry weight of polypeptide-containing component, base, and glycerol or the oligomer of glycerol component and, where present, sodium sulfite, borax, carbohydrate-containing component, or a mixture thereof. The base can be present at 1 wt % to 33 wt %, based on the dry weight of polypeptide-containing component, base, and glycerol or the oligomer of glycerol component and, where present, sodium sulfite, a carbohydrate-containing component, borax, or a mixture thereof A pH of the first mixture can be greater than 10, for example 10.5, 11, 11.5, 12, 12.5, 13, 13.5, or 14.

After combining at (b) is performed, the method further includes (c) combining the mixture produced at (b) with the polypeptide-containing component

Alternately, the polypeptide containing component can first be combined with the wood particles followed by adding the mixture of (a), and in some instances this is preferred. The polypeptide-containing component can be in a powder form. It has been found that the properties of the resulting engineered wood (e.g., internal bond strength) are better when the polypeptide-containing component is in powder form as opposed to a dispersion form.

The polypeptide component is in a range of from 20 wt % to 80 wt % or 30 wt % to 80 wt %, based on the dry weight of polypeptide-containing component, base, and glycerol or the oligomer of glycerol component and, where present, sodium sulfite, a carbohydrate-containing component, borax, or a mixture thereof. The borax can be in a range of from 1 wt % to 15 wt % or 3% to 6%, based on the dry weight of polypeptide-containing component, base, and glycerol or the oligomer of glycerol component, borax component, and, where present, sodium sulfite, a carbohydrate-containing component, or a mixture thereof. The calcium carbonate is present in a range of from 1 wt % to 15 wt % or 3 wt % to 8 wt %, based on the dry weight of polypeptide-containing component, base, and glycerol or the oligomer of glycerol component, calcium carbonate, and, where present, sodium sulfite, a carbohydrate-containing component, borax, or a mixture thereof.

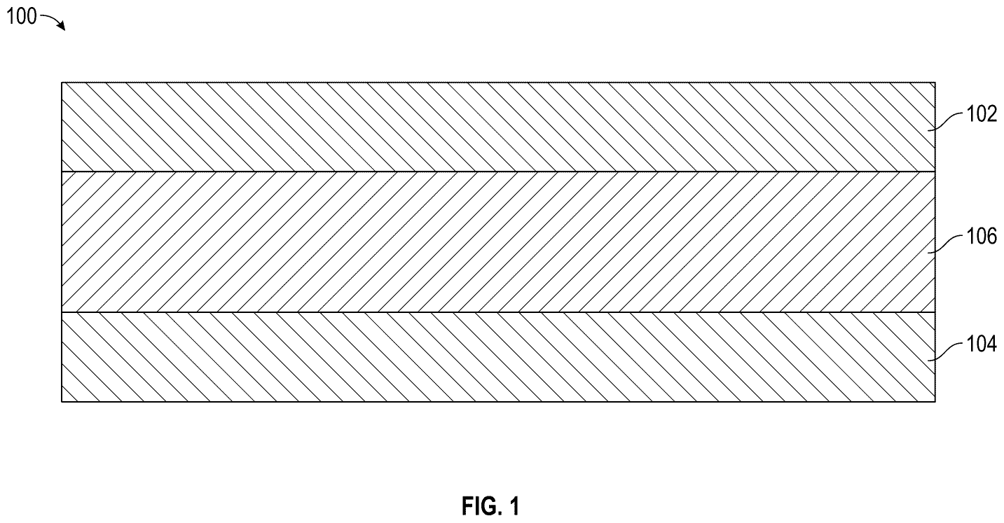

The aforementioned steps create a resinated furnish of one of a first face layer 102, a second face layer 104, or a core layer 106 (as represented in FIG. 1). The steps are repeated to create a resinated furnish of a second face layer 104 and core layer 106, if desired. In some aspects at least one layer may be free of the aforementioned binder and can instead include a urea-formaldehyde resin binder or a methylene diphenyl diisocyanate binder or a polyamide-epichlorohydrin based binder. The resinated furnishes formed from each series of steps are stacked to form a mat. The tack strength of the resinated furnish helps to allow the resinated furnish to remain relatively intact when stacked. Once the mat is formed, it is then cured.

Tack is the adhesive property that imparts upon the materials being bound, the ability to lightly stick together with gentle pressure. Tack is typically an important property for maintaining the shape and distribution of wood particles within the mattress during initial formation throughout the particleboard manufacturing process. Increasing the carbohydrate-containing component portion of the aqueous portion of the binder reaction mixture appears to visually improve the tack properties of the resulting binder reaction mixture. Adding the carbohydrate-containing component can enhance the tack described herein. Although, for example, it may be desirable to keep the concentration of high fructose corn syrup below 20 wt %, for example, below 15 wt %, below 10 wt %, or below 5 wt %.

After combining at step (c) is performed, the method further includes (d) curing the mat to form the engineered wood. Curing can include hot pressing the mat. Hot pressing is performed typically at a pressure of at least 5 psi and at least 10 psi, at least 50 psi, 100 psi and typically less than 500 psi, or from 30 psi to 400 psi.

Typically, a platen of the press used for hot pressing is heated to a temperature of at least 204° C., at least 246° C. in a range of from 204° C. to 315° C., 204° C. to 260° C., 204° C. to 232° C., 204° C. to 226° C., 210° C. to 221° C., less than 315° C., or preferably less than 230° C.

The method can further include a “cold pressing” step that can occur before or after the hot pressing. Cold pressing can occur at ambient temperatures.

Curing above 100° C. causes water to convert to steam that creates an internal gas pressure in the product, which can ultimately cause the wood product to fail in maintaining structural soundness (e.g., blow). This problem is especially present if a urea-formaldehyde based binder if is used. Surprisingly and unexpectedly, using the instantly disclosed binders, it is possible to cure the engineered wood products (by heating to platen to a high temperature) and high mat moisture content (both within the respective ranges described herein) without causing the product to blow.

Any of the swell-retardant components described herein can be added to the wood component at any point during the method. Similarly, sodium sulfite, sodium bisulfite, sodium metabisulfite or a mixture thereof can be added to the method at any step. Furthermore, calcium carbonate can be added to the method at any step.

### EXAMPLES

Various aspects of the present disclosure can be better understood by reference to the following examples which are offered by way of illustration. The present disclosure is not limited to the examples given herein. Unless indicated to the contrary. The wood used in the examples had a moisture content of from about three percent by weight (3 wt %) to about nine weight percent (9 wt %); and % NaOH, % enhanced protein pea flour, % Glycerol, % Na₂SO₃, etc. refer to dry weight percent of the indicated component based on the total dry weight of the binder reaction mixture.

TABLE 1
Materials

| Name | Supplier |
|---|---|
| Enhanced Protein Pea Flour | A dry milled and classified pea flour |
| | having a protein content of 55 wt %, |
| | Available from AGT Foods, Minot ND |
| IsoClear 42% | A high fructose corn syrup, available |
| | from Cargill, Incorporated, Wayzata, |
| | MN. Includes 42 wt % fructose and 52 |
| | wt % glucose and 6% other saccharides |
| Wood Particle (WP) | Wood Particles having an average aspect |
| | ratio (length:width) of greater than 1:1. |
| | Wood particles used in the face layer |
| | typically have a lower average aspect |
| | ratio than the wood particles used in the |
| | core layer. Additionally, the wood |
| | particles used in the face layer have a |
| | smaller average particle size than the |
| | wood particles used in the core layer |
| Crude Glycerol (Crude GLY) | A mixture including 15%-20% water, 3- |
| | 7% NaCl and 55-95% glycerol, available |
| | from Cargill, Incorporated, Wayzata, |
| | MN |
| NaOH | A 50% sodium hydroxide solution |
| | available from Thermo Fischer |
| | Scientific, Waltham, MA |
| Na₂SO₃ | Sodium sulfite, available from Acros |
| | Organics, Fair Lawn, NJ |
| Na₂B₄O₇•10H₂O (Borax) | A sodium tetraborate decahydrate borax, |
| | available from Thermo Fischer |
| | Scientific, Waltham, MA |

A pre-weighed amount of water (W_{A}) and optional components such as Na₂SO₃ are mixed until Na₂SO₃ is dissolved. Then GLY and a polyol component, where present, such as an IsoClear 42% high fructose corn syrup solution and optional components such as borax, are added to the sulfite solution along to form a mixture. A 50% alkaline solution such as an NaOH solution is slowly added to the mixture. The formed mixture is agitated until borax is dissolved. The aqueous solution is allowed to cool down to 25-30° C.

With respect to the W_{A}, the total water content of the binder and wood particle (WP) is targeted at a predetermined value. The ratio of the dry binder to dry wood particle is a preterminal value (e.g., 13 parts per 100 parts of dry WP). The water content to be added to the aqueous portion of the binder reaction mixture is calculated based on the third mixture moisture content, the wood particle moisture and total binder moisture content.

The moisture content of wood particle and polypeptide are measured by a Mettler Toledo moisture balance at 130° C. W_{A} is determined according to Equation 1:

$${W}_{A} = {W}_{T} - {W}_{WP} - {W}_{BF} \qquad ( Equation l )$$

W_{A}: Water to be added to the aqueous portion of the binder reaction mixture
W_{T}: Total moisture of the third mixture
W_{WP}: Water in wood particle
W_{BF}: Water in the binder ingredients including water in polyol component, NaOH, optional borax, optional IsoClear 42, optional MgO, optional, Na₂SO₃, and Prolia 200/90

According to protocol 1A, water, GLY, NaOH, and optional polyol component (e.g., fructose), optional Na₂SO₃, and/or optional borax is blended and sprayed to the wood particles (WP) and mixed for 5 minutes to allow for sufficient dispersion. Where present, water Na₂SO₃, are mixed first followed by glycerol, IsoClear 42 (where present) and optional borax, followed by NaOH. This is followed by the addition of the polypeptide-containing component (and MgO, if added) (Resin 2) in a powder form and that mixture is then blended for 2 minutes.

Alternatively, according to protocol 1B, the polypeptide-containing component (and MgO, if added) (Resin 2) initially includes the wood particle is blended for 0.2-1 minutes. This is followed by blending the GLY, NaOH, and/or optional polyol component (e.g., fructose), optional Na₂SO₃, and optional borax. Where present, water and Na₂SO₃ are mixed first followed by glycerol, IsoClear 42 (where present) and optional borax, followed by NaOH. This mixture is then sprayed to the wood particles, which is pretreated with Resin 2 and mixed for 0.2-1 minute to allow for sufficient dispersion. The two mixtures are then blended for 2 minutes. Either protocol forms a mat, which can be pressed and cured.

A 91.4 cm×91.4 cm Nordberg hot press utilizing a Pressman control system is set at a temperature outlined in the tables below. The combination of the binder and the wood particle described above is uniformly mixed for 2-10 minutes within a Littleford horizontal continuous mixer, available from B&P Littleford, Saginaw, MI, or equivalent apparatus. The resinated furnish is then transferred into at forming box, which is placed on top of a release paper lined caul plate situated on a portable table. The resinated furnish is then evenly distributed across the bottom of the forming box and caul plate to the desired thickness. The same procedure repeated to form a core layer and the second face layer. The mat of the three-layer furnish is then evenly formed in the forming box to the desired thickness. A 76.2 cm×76.2 cm metal collar frame is then placed evenly inside the forming box and on top of the furnish. A metal cover is then placed into the forming box and used to gently push the collar and wood particle together to create a mat that will be pressed. The forming box is then lifted off the bottom caul plate, leaving mat and cover standing alone. The metal cover is carefully removed and a second release paper liner placed on top of the mat, followed by a second caul plate. The entire assembly of the two caul plates with the mat sandwiched between them is then transferred into the hot press.

A temperature and pressure probe is inserted into the center of the mat to monitor internal conditions throughout the pressing cycle. The press platens are then slowly closed to a predetermined distance necessary to maintain a particle board thickness of in a range of from 1.80 cm to 2.16 cm with 1.91 cm being the desired measurement. The mat is held for a time (e.g., a “soak time”) as outlined in the tables below and then bottom platen is slowly lowered within 240 seconds or 30 seconds to release pressure in the particle board. The caul plates and finished particle board are then transferred back onto the movable table. Removing the top caul plate reveals the engineered particle board, which is then placed into a cooling rack. The engineered particle board is removed and allowed to condition at the proper requirements for testing. After conditioning, the engineered particle board is tested for various properties including Internal Bond Strength (IB) measured by ASTM D 1037-06a.

Table 2 represents compositions of formulas used to produce engineered wood products. The engineered wood product formed using Formula 1 includes a core layer bounded by two face layers. Each of face layers and the core layers includes the composition of Formula 1. The core layer accounts for 60 wt % of the engineered wood produce and the face layers together account for 40 wt % of the engineered wood product.

The engineered wood product formed using Formula 2 includes a core layer bounded by two face layers. Each of face layers and the core layers includes the composition of Formula 2. The core layer accounts for 60 wt % of the engineered wood produce and the face layers together account for 40 wt % of the engineered wood product. The engineered wood product's density produced according to these Examples is 0.673 g/cm³.

TABLE 2
Compositions

| | Enhanced | | | | | |
|---|---|---|---|---|---|---|
| | Protein Pea | | IsoClear | | | |
| | Flour | GLY | 42% | NaOH | Na₂SO₃ | Borax |
| | (wt %) | (wt %) | (wt %) | (wt %) | (wt %) | (wt %) |
| Formula 1 | 57% | 20% | 10% | 6% | 2% | 5% |
| Formula 2 | 58% | 29% | — | 6% | 2% | 5% |

Tables 3 and 4 show that it is possible to make an engineered wood product including a protein enhanced pea flour and that the engineered wood product has acceptable internal bond strength values. Also as demonstrated in Table 4 the internal bond strength values increase when protocol 2B is followed.

TABLE 3
Curing conditions and properties of Formula 1

| | Formula 1 |
|---|---|
| Soak time, s | 118 |
| Press Temp, C. | 212 |
| IB PSI | 65 |
| Binder Dose (per 100 parts of the | 13 |
| dry weight of the WF) | |
| Mat Moisture (wt %) | 12% |
| Protocol | 1A |

TABLE 4
Curing conditions and properties of Formula 2

| | Formula 2 |
|---|---|
| Soak time, s | 110 |
| Press Temp, C. | 212 |
| IB PSI | 88 |
| Binder Dose (per 100 parts of the | 13 |
| dry weight of the WF) | |
| Mat Moisture (wt %) | 12% |
| Protocol | 1B |

1. An engineered wood precursor mixture comprising:
a plurality of wood components; and
a binder reaction mixture present in a range of from 3 parts to 25 parts per 100 parts of the dry weight of the plurality of wood components, the binder reaction mixture comprising:
an aqueous portion comprising a glycerol component comprising glycerol or an oligomer of glycerol, the glycerol component being present in a range of from 10 wt % to 65 wt % based on the dry weight of the binder reaction mixture; and
an at least partially non-dissolved polypeptide-containing component in a range of from 20 wt % to 85 wt %, based on the dry weight of the binder reaction mixture, the polypeptide-containing component comprising an enhanced protein pea flour, wherein
the enhanced protein pea flour comprises 40 wt % to 85 wt % protein.

2. The engineered wood precursor mixture of claim 1, wherein the aqueous portion further comprises 1 wt % to 33 wt % of a base, based on a dry weight of the binder reaction mixture.

3. (canceled)

4. The engineered wood precursor mixture of claim 1, wherein a pH of the aqueous portion is greater than 10.

5-8. (canceled)

9. The engineered wood precursor mixture of claim 1, wherein the aqueous portion further comprises:
a carbohydrate-containing component in a range of from 2 wt % to 40 wt %, based on a dry weight of the binder reaction mixture, wherein the carbohydrate-containing component comprises glucose, fructose, sucrose, or a mixture thereof, and the combined wt % of glucose, fructose, sucrose, or a mixture thereof in the carbohydrate-containing component is at least 60 wt %;
sodium sulfite, sodium bisulfite, sodium metabisulfite, or a mixture thereof; and/or borax.

10-14. (canceled)

15. The engineered wood precursor mixture of claim 1, wherein the engineered wood precursor mixture comprises less than 5 wt % of urea-formaldehyde, methylene diphenyl diisocyanate, or a mixture thereof; optionally, the engineered wood precursor mixture is substantially free of urea-formaldehyde, methylene diphenyl diisocyanate, or a mixture thereof.

16-17. (canceled)

18. The engineered wood precursor mixture of claim 1, wherein a moisture content of the binder reaction mixture and the plurality of wood components together is in a range of from 7% to 25%.

19-23. (canceled)

24. A method of making an engineered wood, the method comprising (i) the steps of (a) to (c), wherein:
(a) combining a solid polypeptide-containing component comprising an enhanced protein pea flour, wherein the enhanced protein pea flour comprises 40 wt % to 85 wt % protein with a plurality of wood components;
(b) combining the mixture produced at (a) with an aqueous mixture comprising a glycerol component comprising glycerol or an oligomer of glycerol, water, a base, a sodium sulfite, optionally a carbohydrate-containing component, a borax, or a mixture thereof; and
(c) curing the mixture formed at (b) to form the engineered wood; or
(ii) the steps of (d) to (g), wherein:
(d) combining a glycerol component comprising glycerol or an oligomer of glycerol, water, a base, sodium sulfite, optionally a carbohydrate-containing component, borax, or a mixture thereof;
(e) combining the mixture produced at (d) with a plurality of wood components;
(f) combining the mixture produced at (e) with a solid polypeptide-containing component, the polypeptide-containing component comprising an enhanced protein pea flour, wherein the enhanced protein pea flour comprises 40 wt % to 85 wt % protein; and
(g) curing the mixture formed at (f) to form the engineered wood.

25. (canceled)

26. The method of claim 24, further comprising applying a swell-retardant component to the plurality of wood components.

27. The method of claim 24, wherein the glycerol component is in a range of from 10 wt % to 65 wt % or 10 wt % to 50 wt %, based on the combined dry weight of polypeptide-containing component, base, and glycerol component, sodium sulfite, optional optionally carbohydrate-containing component, borax, or a mixture thereof.

28. (canceled)

29. The method of claim 24, wherein the mixture produced at (d) is applied to the plurality of wood components at (e) by spraying.

30-34. (canceled)

35. The method of claim 24, wherein the mixture produced at (d) or the mixture produced at (b) is aqueous and comprises 1 wt % to 33 wt % of the base, based on the combined dry weight of polypeptide-containing component, base, glycerol component, sodium sulfite, borax, optional carbohydrate-containing component, or a mixture thereof, wherein a pH of the second mixture greater than 10;
wherein the polypeptide component is in a range of from 20 wt % to 80 wt %, based on the combined dry weight of polypeptide-containing component, base, glycerol component, sodium sulfite, borax, optional carbohydrate-containing component, or a mixture thereof;
wherein the carbohydrate-containing component comprises glucose, fructose or mixtures thereof and the total weight percent of glucose and fructose is in the range of 2 wt % to 30 wt %, based on the combined dry weight of polypeptide-containing component, base, glycerol component, sodium sulfite, borax, optionally carbohydrate-containing component, or a mixture thereof, the carbohydrate-containing component comprising, fructose, glucose, sucrose, or a mixture thereof at least 60 wt %; and/or
wherein the borax is in a range of from 1 wt % to 15 wt %, based on the combined dry weight of polypeptide-containing component, base, glycerol component, sodium sulfite, borax, optional carbohydrate-containing component, or a mixture thereof.

36-40. (canceled)

41. The method of claim 24, wherein the mixture(s) produced at (a), (b), (c), (d), (e), (f), (g), or a combination thereof is substantially free of urea-formaldehyde, methylene diphenyl diisocyanate, or a mixture thereof.

42-54. (canceled)

55. An engineered wood comprising a reaction product of the engineered wood precursor mixture of claim 1.

56. The engineered wood of claim 55, wherein the engineered wood comprises particle board, medium density fiber board, high density fiberboard, oriented strand board, engineered wood flooring, or a combination thereof.

57. The engineered wood of claim 55, wherein a reaction product of the binder reaction mixture is in a range of from 3 parts to 25 parts per 100 parts of the dry weight of the plurality of wood components of the engineered wood bound together by the reaction product of the binder reaction mixture.

58. (canceled)

59. The engineered wood of claim 55, wherein an internal bond strength of the engineered wood is in a range of from 40 psi to 120 psi.

60. (canceled)

61. The engineered wood of claim 55, wherein the engineered wood is a single layer board or a multi-layer board.

62. (canceled)

63. The engineered wood of claim 61, wherein the multi-layer board comprises:
a first face layer;
a second face layer; and
a core layer between the first and second face layers, wherein
at least one of the first face layer, second face layer, and core layer comprise the reaction product.

64. The engineered wood of claim 55, wherein the engineered wood is free of urea-formaldehyde, methylene diphenyl diisocyanate, or a mixture thereof and another layer the multi-layer board comprises urea-formaldehyde, methylene diphenyl diisocyanate, or a mixture thereof.

65. (canceled)

66. The method of claim 55, wherein curing is performed at a temperature of at least 204° C..

67-70. (canceled)
